(19) United States
(12) Patent Application Publication
(10) Pub. No.: US 2006/0146553 A1
(43) Pub. Date: Jul. 6, 2006

(54) Dimmable reading light with emergency lighting capability

(75) Inventors: Samuel Zeng, Flushing, NY (US); Peter Buitenkant, Dix Hills, NY (US); Amy Grumet-Avallone, Smithtown, NY (US)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: B/E Aerospace, Inc., Wellington, FL (US)

(21) Appl. No.: 11/246,810

(22) Filed: Oct. 7, 2005

Related U.S. Application Data
(60) Provisional application No. 60/616,975, filed on Oct. 8, 2004.

(51) Int. Cl. B60Q 1/26

(52) U.S. Cl. 362/488; 362/545

(57) ABSTRACT

Provided are a reading light assembly for a vehicle and a field replaceable unit for an in-vehicle reading light assembly. An embodiment of the reading light assembly for a vehicle includes a housing for attaching the reading light assembly to an interior portion of the vehicle and a field replaceable unit for engaging with the housing. An embodiment of the field replaceable unit includes a power module including a power interface for receiving operational power from a power source, a light module including a plurality of LEDs, and a control module that includes a control interface for receiving a user input signal from a user input device so that the control module can vary a light intensity that is output from the plurality of LEDs according to the user input signal. In some embodiments the reading light assembly and field replaceable unit include a second power interface for receiving power from a secondary power source when the primary power source is interrupted so that the light assembly is operable to function as an in-vehicle emergency light.

### CROSS-REFERENCE TO RELATED PATENT APPLICATIONS

This patent application claims the benefit of U.S. Provisional Patent Application No. 60/616,975, filed Oct. 8, 2004.

### FIELD OF THE INVENTION

This invention generally pertains to lighting fixtures and, more particularly, to dimmable lighting fixtures for illuminating a vehicle interior.

### BACKGROUND OF THE INVENTION

Lighting systems and fixtures for illuminating a vehicle interior are generally known. One type of lighting fixture that is often employed in a vehicle (e.g., car, bus, train, aircraft, etc.) is a reading light, which helps passengers read, work, etc., particularly while traveling at night and through areas with inadequate natural or ambient lighting. One type of conventional reading light includes light emitting diodes (LEDs) due to their inherent properties including, but not limited to, long life, low power consumption and high lumen output.

One problem associated with LED reading lights is that they operate only at one of two discrete states. That is, a conventional LED reading light is either de-energized (i.e., off) or energized (i.e., on) for outputting a “full bright” (i.e., maximum intensity) light. Consequently, a user (i.e., vehicle passenger) can only operate a reading light at its brightest setting even though it may be desirable or necessary to operate the light at a lower intensity setting, for example to avoid disturbing nearby passengers who are sleeping or watching an in-flight movie. Thus, since the reading light cannot be dimmed, vehicle passengers wanting to read or work often forego such tasks out of courtesy to their fellow passengers. To overcome a lack of dimming capability, some conventional reading lights include a means (e.g., louvers, etc.) for a user to direct or focus the light away from other vehicle occupants thereby providing their fellow travelers with limited relief from the full bright light. However, such a means is often prone to breakage due to repeated handling by users and may not be practicable in many situations. Therefore, an electronically-dimmable LED reading light would be desirable.

Furthermore, in vehicles such as aircraft, a secondary lighting system that is separate from a primary lighting system and includes hardware (e.g., light fixtures, backup power source, controls and wire harnessing) is designed into the vehicle interior to provide lighting in emergency situations such as, for example, momentary or sustained outages of vehicle power. Disadvantageously, this separate and additional emergency lighting system adds cost, complexity and weight to a vehicle. To this end, it would be desirable for an interior vehicle light, such as an LED reading light, to provide lighting during emergency situations, for example, by overriding the individual passenger control of the light when the emergency is sensed and the light switches to the backup power source (e.g., battery, emergency bus, etc.).

In view of the foregoing, an improved reading light for a vehicle would be welcomed.

### BRIEF SUMMARY OF THE INVENTION

Provided are a reading light assembly for a vehicle and a field replaceable unit for an in-vehicle reading light assembly. An embodiment of the reading light assembly for a vehicle includes a housing for attaching the reading light assembly to an interior portion of the vehicle and a field replaceable unit for engaging with the housing. An embodiment of the field replaceable unit includes a power module including a power interface for receiving operational power from a power source, a light module including a plurality of LEDs, and a control module that includes a control interface for receiving a user input signal from a user input device so that the control module can vary a light intensity that is output from the plurality of LEDs according to the user input signal.

### BRIEF DESCRIPTION OF THE DRAWINGS

FIG. 1 is a block diagram of a reading light assembly for illuminating a vehicle interior;

FIG. 2 is a front perspective view of one embodiment of the reading light assembly of FIG. 1;

FIG. 3 is a side view of the embodiment of FIG. 2;

FIG. 4 is an exploded view illustrating internal components of the embodiment of FIG. 2; and

FIG. 5 is an example schematic diagram for the embodiment of FIG. 2.

### DETAIL DESCRIPTION OF THE EMBODIMENTS

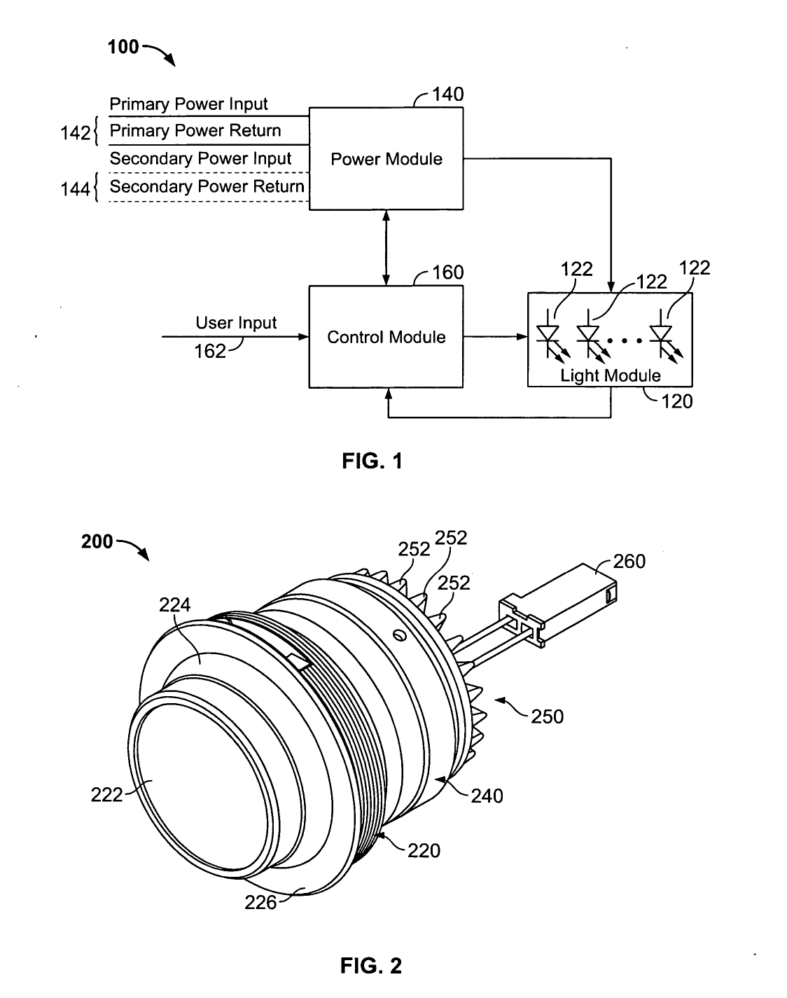

Referring now to the Figures a reading light assembly is provided. Although the subject reading light assembly is described hereafter in the context of being used in vehicles such as cars, vans, busses, trains and aircraft for illuminating the vehicle interior, one can appreciate that the subject reading light assembly can be used in other environments, for example, in residences, offices, libraries and other locations where individuals require illumination to read, work, etc. As shown in FIG. 1 an embodiment of the reading light assembly 100 includes a light module 120, a power module 140 and a control module 160. The light module 120 includes a plurality of lights 122, although a single light may also be used. As further shown in FIG. 1, each light 122 may be a light emitting diode (LED), but other types of lights known in the art (e.g., incandescent lights) may be suitable as well.

The power module 140 is connected to the light module 120 and the control module 160 for supplying voltage and current thereto. Alternatively, the light module 120 may only be connected to and receive operational power from the control module 160. The power module 140 may include a power protection means such as a fuse, relay or the like for protecting the reading light assembly 100 and lighting system (not shown), of which the assembly 100 may be a part, against damage due to short circuits, power surges and other conditions and malfunctions. Furthermore, the power module 140 may include a power conversion means for stepping down or otherwise converting the input power (i.e., current and voltage) of the reading light assembly 100 to a suitable power for use by the light module 120 and control module 160. For example, when the reading light assembly is configured for connection to an AC source such as a 120 volt household outlet, the power module 140 may include an AC to DC converter. In another example, when the reading light assembly 100 is configured for connection to a DC source such as a 12 or 28 volt system, the power module 140 may include a DC to DC converter. Additionally, the power module 120 may include a regulating means for providing, for example, a regulated voltage to the light module 120 and the control module 160.

As shown in FIG. 1, the power module 140 includes a first interface 142 for receiving power from a primary or normal power source. Furthermore, the power module 140 may include a second interface 144 for receiving power from a secondary or emergency power source such as a battery, an emergency bus or the like. As can be appreciated, the power module 140 may include one or more sensors such as, current and/or voltage sensors known in the art, for sensing current and/or voltage at least one of the first and second interfaces 142, 144. For example, the power module 140 may include a sensor in communication with the first interface 142 to detect an interruption or outage of the primary power source. In another example, when the second interface 144 is configured to receive power from an emergency bus that is selectively energized (e.g., during an outage of the primary power source), the power module 140 may include a sensor in communication with the second interface 144 to detect energization of the secondary power source. The power module 140 may include a switch means (e.g., a relay or the like) in communication with the one or more sensors for switching the input power (i.e., switching from the primary power source to the secondary power source) to the reading light assembly 100 to maintain operation of the light module 120 and the control module 160. Further, in some embodiments, upon one of the sensors detecting the restoration of primary power and communicating the restoration to the switch means, the switch means may return the input power (i.e., switching from the secondary power source to the primary power source) to prevent depletion of the secondary power source.

The control module 160 is configured to control operation of the light module 120 and includes a control means such as a microprocessor, microcontroller, programmable logic controller (PLC), field programmable gate array (FGPA), state machine or the like. The control module 160 includes an interface 162 for receiving a user input signal from an input device that is actuated by a user of the reading light assembly 100. As known in the art, an input device such as a button, switch, dial, joystick, joypad, keyboard and the like may be employed to provide a user input signal to the control module 160. Furthermore, a combination of two or more of the foregoing exemplary input devices may be employed as well. For example, in an aircraft, the input device may be an actuator (e.g., snap-dome button, contact microswitch, etc.) that is located proximate the overhead reading light assembly 100 or, alternatively, distal from the assembly 100 on a passenger armrest as a part of the passenger service system (PSS) that includes other actuators for attendant call, controlling in-flight music station and volume and the like.

As can be appreciated, the input device is configured to provide one or more signals to the control module 160 for varying the state of the light module 120. In one embodiment, the control module 160 is configured to detect a momentary switch to ground signal from the input device for switching the light module 120 between its on and off states and one or more intermediate dim states. For example, a user may actuate the input device a number of times to cycle the light module 120 between a fully bright on state, an off state and at least one dim on state between the fully bright on state and the off state. In this way, a user may selectively dim the output according to the number of times the input device is actuated. In another example, the input device may include a first actuator (e.g., a button or switch) that sends a first signal to the control module 160 for turning the light module on and off, and a second actuator (e.g., a dial rheostat or potentiometer) that sends a second signal to the control module 160 for continuously or discretely (i.e., stepwise) varying the illumination intensity of the light module 120 once it is turned on according to the first signal. As such, a user may be able to ramp the illumination intensity up and down to customize the light output of reading light assembly 100 to their liking. Indeed, a person of skill in the art will appreciate that the control module 160 may be configured in various ways to vary or otherwise control the illumination intensity of light module 120 according to a user input signal from an input device. As known in the art, the control module 160 may selectively control the illumination by turning on and off one or more individual lights 122. Alternatively, the control module 160 may communicate with the power module 140 to vary at least one of voltage and current (e.g., a PWM output) provided to the light module 120.

Turning now to FIGS. 2-4, one embodiment of the reading light assembly 100 (FIG. 1) is an LED reading light for a vehicle. As shown in FIG. 2, the LED reading light 200 includes a housing 220 and a light field replaceable unit (FRU) 240 that removably attaches to the housing 220. The housing 220 is configured to provide mechanical protection and structural support for the FRU 240. As can be appreciated, the housing 220 protects the FRU 240 from shock, vibration, temperature, and humidity or other moisture as required to comply with vehicle safety standards (e.g., FAA, NHTSA, etc.) In some embodiments, the housing 220 is constructed of a metal such as aluminum, but other suitable materials may be employed as well such as some plastic materials. Another example housing 220 that may be employed with the FRU 240 is disclosed in U.S. Pat. No. 6,161,910, issued Dec. 19, 2000 to Reisenauer et al. for “LED Reading Light”, the disclosure of which is incorporated herein in its entirety. The housing 220 includes a cylinder with a distal end that retains a lens 222. As known in the art, the lens 222 may be of the holographic type for integrating the light produced by the plurality of lights 122 (FIG. 1) into a homogeneous light pattern. The proximal end of the cylinder is attached to a ball 224 for movably directing the homogeneous light pattern from the lens 222 onto an object or area as desired by the user. In one embodiment, the ball 224 may be friction fit or the like on a portion of the housing 220 such that a force required to rotate the ball 224 is in the range of about 1.0 pounds and 5.5 pounds as applied at the distal end of the cylinder and perpendicular thereto. As further shown, the housing 220 includes a flange 226 for mounting the vehicle reading light 200 to a portion of the vehicle interior, for example a baggage compartment above a passenger seat.

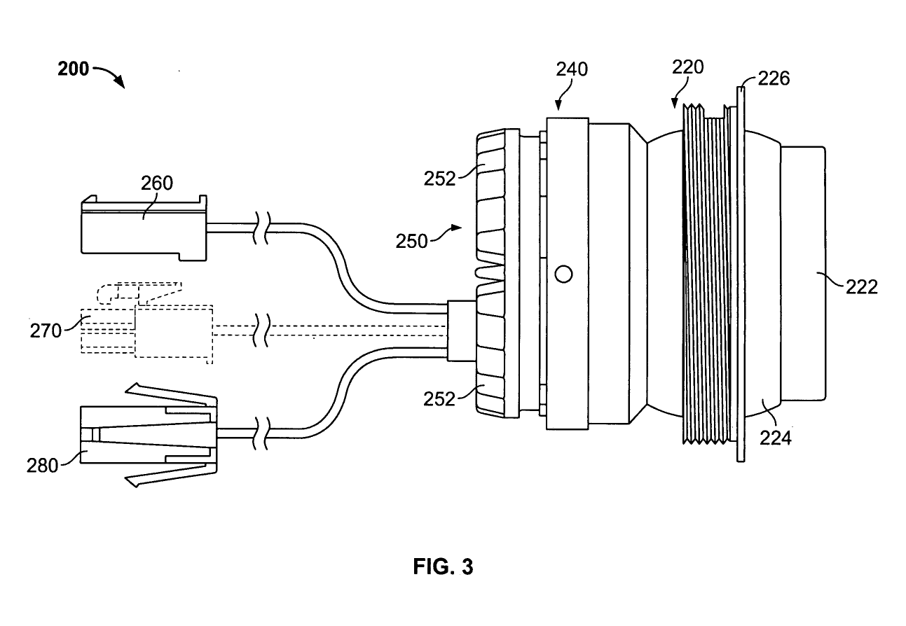

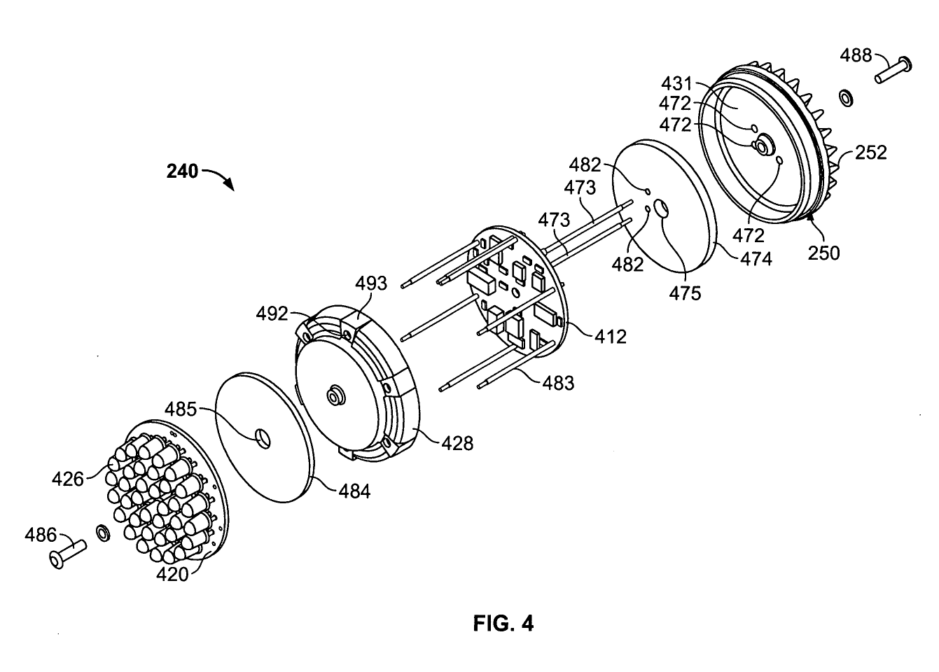

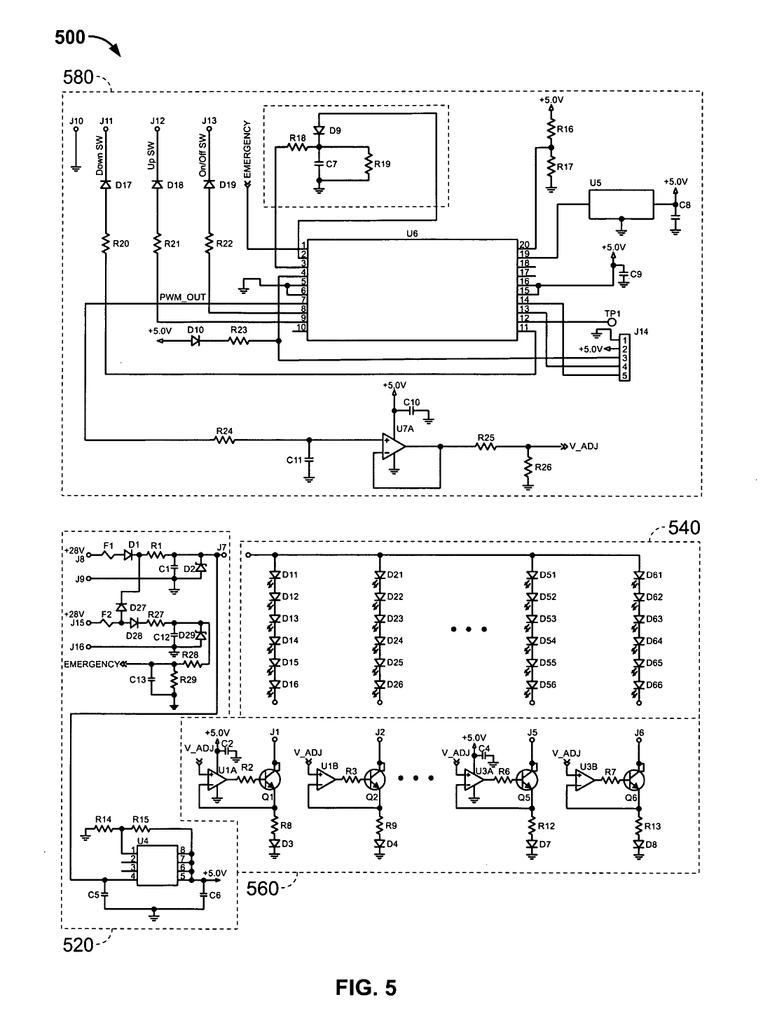

As shown in FIG. 4, the FRU 240 includes a plurality of lights, herein LEDs 426, at its proximal end. As can be appreciated from FIGS. 2-4, the plurality of LEDs 426 is disposed within the housing 220 when the FRU 240 is engaged with the housing 220. Furthermore, as shown in FIGS. 2-4, the FRU 240 includes a heat sink 250 with a plurality of fins 252 (best illustrated in FIG. 3) at its distal end that dissipate heat generated by the plurality of LEDs 426. The plurality of fins 252 may be configured on the distal surface of heat sink 250 in a radial pattern or any other suitable arrangement as desired. The FRU 240 also includes connector 260 for removably coupling the light 200 with a power source and/or user input device. Connector 260 facilitates replacement of the FRU 240 if, for example, one or more LEDs 426 fail to illuminate, or if the FRU 240 malfunctions or otherwise fails to operate properly. As shown in FIG. 3, the FRU 240 may include additional connectors 270, 280 for separating the connections to power sources (e.g., primary and secondary power sources) from a connection to a user input device. Referring back to FIG. 1, primary and secondary power source interfaces 142, 144 may correspond with respective connectors 260, 270 (or vice versa) and user input interface 162 may correspond with connector 280. As can be appreciated, connectors 260, 270 each may be configured as two-pin, two-wire connectors for power input and power return. Further, connector 280 may be configured as a four-pin, four-wire connector for receiving an on/off signal, an increase illumination signal, a decrease illumination signal and power return.

As further shown in FIG. 3, the connectors 260, 270, 280 are preferably shaped and sized (i.e., keyed) differently. In this way, the plugging of one connector into a jack meant to receive another connector is obviated, thereby preventing improper installation and accidental damage to the FRU 240. That is, connector 260 cannot be mated with a jack that is configured to receive connector 270 and also cannot be mated with a jack that is configured to receive connector 280. Similarly, connector 270 cannot be mated with a jack that is configured to receive connector 260 and also cannot be mated with a jack that is configured to receive connector 280. Finally, connector 280 cannot be mated with a jack that is configured to receive connector 260 and also cannot be mated with a jack that is configured to receive connector 270. In some embodiments the FRU 240 may include a single connector with a plurality of pins that is connected to the FRU 240 by a plurality of wires.

Referring now to FIG. 4, internal components of the LED reading light 200, particularly the FRU 240, are shown. As shown in FIG. 4, the example FRU 240 includes an LED assembly comprising a plurality of LEDs 426 mounted on a board 420 (e.g., a PCB). As shown, thirty six LEDs are mounted to the board 420, but fewer or additional LEDs may be provided. A front portion 428 of heat sink 250 is disposed behind the board 420 and a front thermal pad 484 is interposed between the front portion 428 and the board 420. As shown, the front thermal pad 484 includes a central aperture 485 through which fastener 486 is inserted for mounting the board 420 to the front portion 428 of heat sink 250. A rear portion 431 of heat sink 250 includes a rear surface with a plurality of radially-arranged fins 252. Further, a plurality of wire-receiving apertures 472 are configured on the rear portion 431 for receipt of wires 473 (two wires 473 are shown, but additional wires may be provided) that extend from circuit board 412. Wires 473 connect the circuit board 412 to a wiring harness, bus or the like to receive power and user input signals for controlling operation of the FRU 240 and wires 483 connect the circuit board 412 to board 420 and the plurality of LEDs 426 thereon. As can be appreciated, the power and control means (e.g., FIG. 1, power module 140 and control module 160) are implemented on the circuit board 412 that is disposed internal to the FRU 240, but in some embodiments at least one of the power and control means may be disposed external to the FRU 240.

A rear thermal pad 474 that may be similar or different from front thermal pad 484 is interposed between the circuit board 412 and rear portion 431 of heat sink 250. As shown, the rear thermal pad 474 includes a plurality of apertures 482 for receiving the wires 473 of circuit board 412. Apertures 482 are aligned with apertures 472 of the rear portion 431 of heat sink 250 so that wires 473 may extend externally from the FRU 240. As further shown, circuit board 412 is sandwiched between front and rear portions 428, 431 of heat sink 250 to prevent overheating the plurality of electrical components thereon. As shown, there are a plurality of electrical components such as resistors, capacitors, inductors, transistors, integrated circuits (ICs) such as microprocessors and the like. One exemplary configuration of the of electrical components on the circuit board 412 is shown in the schematic of FIG. 5, which will be described hereafter in further detail. Circuit board 412 is linked with LED board 420 via a plurality of wires 483. As shown, the plurality of wires 483 extends through a plurality of arcuately-spaced holes 492 to exit the interior of heat sink 250 and connect with the LED board 420.

Fasteners 486, 488, for example, screws, bolts, etc., connect the various components of the FRU 240 together. Fastener 486 mounts LED board 420 and front thermal pad 484 to the front side of front portion 428 of heat sink 250 through aperture 485. Fastener 488 mounts back thermal pad 474 and circuit board 412 to the back portion 431 of heat sink 250. When assembled, LED FRU 240 is relatively compact in size. Heat generated by the plurality of LEDs 426 on board 420 is transferred via conduction to the front portion 428 of heat sink 250. Heat flows radially outward to the outer circumference 493 of the front portion 428 and then rearward to the plurality of fins 252 for dissipation, thereby preventing overheating of both the LEDs 426 and circuit board 412.

The circuit board 412 includes a controller (e.g., control means 160 of FIG. 1) such as a microprocessor that executes logic or algorithms programmed thereon for controlling foregoing-described operation (e.g., dimming, emergency lighting) of the light 200 according to received user input signals and the current operating state of the FRU 240. For example, in some embodiments the controller may be programmed to ignore signals from the user input device when the light 200 is being powered from the secondary power source, thereby preventing a vehicle passenger from dimming the light 200 when it is being used for emergency illumination. Furthermore, the FRU 240 may include a temperature sensor such as a thermistor, thermocouple of the like for increasing longevity of the FRU 240. For example, the temperature sensor may be located proximate to or on the board 420 for determining heat output from LEDs 426. Alternatively, the temperature sensor may be located on the circuit board 412 for sensing temperature inside the heat sink 250 for protecting the controller. As known in the art, temperature sensor monitors a temperature in FRU 240 and outputs a signal proportional to the sensed temperature to the controller. Relative to the signal that is output from the temperature sensor, the controller may reduce the power to the plurality of LEDs 426, selectively disable one or more LEDs of the plurality 426 or the like when the sensed temperature rises above a predetermined threshold value, for example, the rated continuous values of the LEDs 426. In this way, FRU controller continuously monitors the operating temperature of the FRU 240 and outputs signals to compensate for high operating temperatures to maintain maximum illumination over a wide range of ambient temperatures.

Referring now to FIG. 5, an example schematic is provided for implementing the LED FRU 240 in accordance with the assembly 100 of FIG. 1. As shown in FIG. 5, the circuit 500 includes a power module 520, a light module 540, a driving module 560 and a control module 580. The power module 520 includes a first interface J8, J9 for receiving power from a primary 28 volt DC source and a second interface J15, J16 for receiving power from an emergency 28 volt DC source. As shown, the first interface J8, J9 includes fuse F1, resistor R1, capacitor C1 and diodes D1, D2 for short circuit/overcurrent protection and voltage conditioning of the primary source. Similarly, the second interface J15, J16 includes fuse F2, resistor R27, capacitor C12 and diodes D28, D29 for short circuit/overcurrent protection and voltage conditioning of the emergency source. The power module 520 provides 28 volt DC operational voltage to the light module 540 at J7. Furthermore, the power module 520 provides an output signal EMERGENCY to the control module 580 when the second interface J15, J16 is energized. As previously mentioned, having received the EMERGENCY signal, the control module 580 may, for example, disable user-actuated dimming of the light module 540 and energize the light module 540 via signal V_ADJ, which will be discussed hereafter in further detail, to output a maximum illumination level or other level sufficient for emergency lighting. The power module 520 also includes a combination DC/DC converter and voltage regulator U4 for providing regulated voltage (e.g., 5.0 volts as illustrated) to various circuit components in circuit 500.

As further shown in FIG. 5, the light module 540 includes a plurality of LEDs. As can be appreciated, the LEDs are arranged in six strings of six series-connected LEDs. That is, a first LED string includes LEDs D11-D16, a second LED string includes LEDs D21-26, and so on. Thus, as shown, the light module 540 includes a total of thirty-six LEDs, but fewer or additional LEDs can be provided by, for example increasing or decreasing the quantity of LED strings.

A driving module 560 connects with the light module 540 at J1-J7. Although the driving module 560 is illustrated as being separate from the light module 540, the driving module 560 may be integral with the light module 540. Alternatively, the driving module 560 may be integral with the control module 580. As shown, the driving module 560 includes six driving circuits, each of which connects with one of the six LED strings. Each driving circuit includes a transistor (Q1-Q6) and an operational amplifier (U1A, U1B through U3A, U3B) as shown. The operational amplifier of the driving circuit drives the base of the transistor to vary the emitter current and therefore controlling the current through the LED string that is connected to the driving circuit. Thus, as can be appreciated, the driving circuits are configured to dim and brighten the output illumination of LED strings according to the signal V_ADJ from the control module 580. Although each driving circuit receives the same signal, V_ADJ, from the control module 580, the control module 580 may be configured to provide more than one output signal to the various driving circuits in driving module 560 such that the control module 580 can selectively dim and turn on and off the various LED strings.

As illustrated, the control module 580 includes a control interface J10-J13 for receiving user-actuated input signals from a user interface device. The control module 580 further includes a processor U6, a temperature sensor U5, a USART interface TP1 and an ICSP interface J14. The control interface J10-J13 as shown is connected with processor U6 for providing the input signals thereto. As shown, the user input signals provided to the processor U6 from the user interface device are DOWN SW (J11) for dimming the light module 540, UP SW (J12) for increasing illumination of the light module 540 and ON/OFF SW (J13) for energizing and deenergizing the light module 540. The processor U6 may be any type of integrated circuit (IC) known in the art such as a microprocessor, microcontroller, digital signal processor (DSP) or the like. In one embodiment the processor U6 is a PIC16F88 microprocessor available from Microchip Technology, Inc. The temperature sensor U5 is connected to the processor U6 for outputting a signal according to the ambient temperature within or proximate to the FRU 240. The temperature sensor U5 may be a thermistor or an IC temperature sensor such as an LM50 available from the National Semiconductor Corporation. The processor U6 outputs a signal PWM_OUT to the driving module 560 according to: user-actuated input signals received from the control interface J10-J13; the EMERGENCY signal discussed above; and an output from temperature sensor U5. Output signal PWM_OUT from processor U6 is a pulse width modulated (PWM) type signal, but may be other types of analog and digital signals as known in the art.

As shown, the circuit block that is connected to processor U6 and includes resistors R18 and R19, capacitor C7 and diode D9 is configured for preserving the user-settings during a short duration (e.g., less than 3 seconds) power interruption. That is, if a primary power interruption of short duration occurs, the microprocessor, in cooperation with the foregoing-described circuit block, can restore the user-settings from the microprocessor internal memory. Thus, the light can automatically reset its light output level to its previous state after the primary power is restored. For example, if the user has set the reading light to output a dim illumination level and the primary power is momentarily interrupted, the light may first output an emergency (e.g., full bright) illumination level and then, when the primary power is restored, revert to the user-set dim illumination level without user intervention. As further shown, a universal synchronous asynchronous receiver transmitter (USART) interface TP1 is connected to processor U6 for interfacing the control module 580 with peripheral devices such as display terminals, personal computers and the like. For example, a computer may be connected to USART interface TP1 for debugging the firmware loaded on and executing on the processor U6, for QC testing of the FRU 240 or the like. Furthermore, an in-circuit serial programming (ICSP) interface J14 is connected with the processor U6 for serial programming of firmware on the processor U6. Using ICSP interface J14, the end-user of FRU 240 may field-load user, application or context/environment specific firmware on the FRU 240 or upgrade firmware as necessary.

With the circuit 500 configured as foregoing-described, exemplary operation of the FRU 240 is now described:

When the light module 540 is off and the processor U6 receives the ON/OFF signal on interface J13, the processor U6 outputs a signal PWM_OUT to driving module 560 to energize the light module 540. The light module 540 may be turned on at its brightest output illumination level, its dimmest output illumination level or at an output illumination level intermediate the brightest and dimmest levels. When the light module 540 is on and the processor U6 receives the ON/OFF signal on interface J13, the processor U6 outputs a signal PWM_OUT to driving module 560 to deenergize the light module 540. When the light module 540 is on and the processor U6 receives the DOWN signal on interface J11, the processor U6 outputs a signal PWM_OUT to driving module 560 to dim the light module 540. A user actuating a dimming button, down button or the like of a user interface device multiple times may output successive DOWN signals to further dim the light module 540 in, for example, a stepwise manner. If the light module 540 is at its dimmest illumination level and the processor U6 receives the DOWN signal, the processor U6 may ignore the signal, for example.

When the light module 540 is on and the processor U6 receives the UP signal on interface J12, the processor U6 outputs a signal PWM_OUT to driving module 560 to increase brightness of the light module 540. A user actuating a brighten button, up button or the like of a user interface device multiple times may output successive UP signals to further increase output illumination of the light module 540 in, for example, a stepwise manner. If the light module 540 is at its brightest illumination level and the processor U6 receives the UP signal, the processor U6 may ignore the signal, for example.

If the processor U6 receives the EMERGENCY signal and the light module 540 is off, the processor U6 outputs a signal PWM_OUT to driving module 560 to illuminate the light module 540 at the emergency lighting output intensity, for example, the brightest output illumination level. If the processor U6 receives the EMERGENCY signal and the light module 540 is on and dimmed, the processor U6 outputs a signal PWM_OUT to driving module 560 to illuminate the light module 540 at a brighter output illumination level, for example, the brightest output illumination level. Furthermore, having received the EMERGENCY signal, the processor U6 may discard or otherwise ignore signals received on interfaces J10-J13 from a user interface device. If the primary power source is restored and output of the EMERGENCY signal is terminated, the processor U6 may return the light module 540 to its previous state, that is, the light module 540 state (e.g., full bright, dim, etc.) before the processor U6 received the EMERGENCY signal.

Furthermore, the temperature sensor U5 may be continuously, regularly or randomly detecting the ambient temperature of the circuit 500. To this end, the processor U6 is receiving a signal from the temperature sensor U5 and determining if the temperature is at or above a predetermined, programmed temperature threshold to prevent overheating thereof and damage to the various circuit components. If the processor U6 determines that the temperature is above the temperature threshold, the processor U6 may output a signal PWM_OUT to driving module 560 to dim the light module 540, selectively turn off one or more LED strings therein or the like.

Of course, a person of ordinary skill in the art will appreciate that the processor U6 may be configured to operate the light 200 (i.e., FRU 240) differently.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A reading light assembly for a vehicle, comprising:
a housing configured to attach the reading light assembly to an interior portion of the vehicle; and
a field replaceable unit for engaging with the housing, the field replaceable unit comprising:
a sensor;
a power module including a power interface for receiving operational power from a power source;
a light module including a plurality of LEDs; and
a control module connected with the power module and the light module and including a control interface for receiving a user input signal from a user input device, wherein the control module varies a light intensity that is output from the plurality of LEDs according to the user input signal.

2. The reading light assembly of claim 1 wherein the power module further comprises a second power interface for receiving operational power from a secondary power source.

3. The reading light assembly of claim 2 wherein the sensor comprises a power sensor coupled with the power interface, the power sensor detecting an interruption of the power source and outputting an emergency signal to the control module, wherein, according to the emergency signal, the control module switches the power module to the secondary power source and controls the light module to output an emergency light intensity.

4. The reading light assembly of claim 3 wherein the control module ignores the user input signal after receiving the emergency signal.

5. The reading light assembly of claim 3 wherein the power sensor comprises at least one of a voltage sensor and a current sensor.

6. The reading light assembly of claim 1 wherein the sensor comprises a temperature sensor, the temperature sensor detecting a temperature of the field replaceable unit and outputting to the control module a signal proportional to the temperature, and wherein the control module controls the light module to decrease the light intensity if the temperature is greater than a predetermined threshold.

7. The reading light assembly of claim 6 wherein the temperature sensor is integral with the light module.

8. The reading light assembly of claim 6 wherein the temperature sensor is integral with the control module.

9. The reading light assembly of claim 6 wherein the temperature sensor comprises at least one of a thermistor and a thermocouple.

10. The reading light assembly of claim 1 wherein the control module comprises a microprocessor.

11. A field replaceable unit for an in-vehicle reading light, comprising:
a power module including a first power interface for receiving operational power from a primary power source, a second power interface for receiving operational power from a secondary power source and a sensor for detecting an interruption of the primary power source;
a light module including a plurality of LEDs; and
a control module connected with the power module and the light module, the control module including a microprocessor and a control interface for receiving a user input signal from a user input device, wherein the microprocessor outputs a control signal to vary a light intensity that is output from the light module according to the user input signal.

12. The field replaceable unit of claim 11 wherein the microprocessor ignores the user input signal after receiving an emergency signal that is output from the sensor upon detection of the interruption of the primary power source.

13. The field replaceable unit of claim 11 wherein the sensor comprises at least one of a voltage sensor and a current sensor.

14. The field replaceable unit of claim 11 further comprising a temperature sensor, the temperature sensor detecting a temperature of the field replaceable unit and outputting to the microprocessor a temperature signal proportional to the temperature, and wherein the microprocessor controls the light module to decrease the light intensity if the temperature is greater than a predetermined threshold.

15. The field replaceable unit of claim 14 wherein the temperature sensor is integral with the light module for sensing a heat output from the plurality of LEDs.

16. The field replaceable unit of claim 14 wherein the temperature sensor is integral with the control module.

17. The field replaceable unit of claim 14 wherein the temperature sensor comprises at least one of a thermistor and a thermocouple.

18. The field replaceable unit of claim 11 further comprising a heat sink in thermal communication with the plurality of LEDs.

19. An in-vehicle LED reading light comprising:
a housing; and
a field replaceable unit connected with the housing and comprising:
a power module including a first power interface for receiving operational power from a primary power source, a second power interface for receiving operational power from a secondary power source and a sensor for detecting an interruption of the primary power source;
a light module including a plurality of LEDs; and
a control module connected with the power module and the light module, the control module including a microprocessor and a control interface for receiving a user input signal from a user input device, wherein the microprocessor outputs a control signal to vary a light intensity that is output from the plurality of LEDs according to the user input signal.

20. The in-vehicle LED reading light of claim 19 wherein the field replaceable unit further comprises a temperature sensor for detecting a temperature of the field replaceable unit and outputting to the microprocessor a temperature signal proportional to the temperature, and wherein the microprocessor controls the light module to decrease the light intensity that is output from the plurality of LEDs if the temperature is greater than a predetermined threshold.
